(19) United States
(12) Patent Application Publication
(10) Pub. No.: US 2025/0092652 A1
(43) Pub. Date: Mar. 20, 2025

(54) DRAIN CLEANING DEVICE

(71) Applicant: MILWAUKEE ELECTRIC TOOL CORPORATION, Brookfield, WI (US)

(72) Inventors: Ka Seng Lim, Milwaukee, WI (US); Jose J. Loor, Milwaukee, WI (US); Justin Miller, Richfield, WI (US)

(21) Appl. No.: 18/884,774

(22) Filed: Sep. 13, 2024

Related U.S. Application Data
(60) Provisional application No. 63/624,404, filed on Jan. 24, 2024.
(60) Provisional application No. 63/582,972, filed on Sep. 15, 2023.

(51) Int. Cl. E03C 1/302

(52) U.S. Cl. CPC E03C 1/302

(57) ABSTRACT

A drain cleaning device includes a housing; a drum assembly supported by the housing, the drum assembly including an inner drum, an outer drum, and a space defined therebetween, the drum assembly configured to rotate relative to the housing about a rotation axis; a motor supported by the drum assembly, the motor including an output shaft; a flexible cable stored within the space of the drum assembly, the flexible cable operable to receive torque from the motor; and a drum cover supported by the housing and positioned over the space to maintain the flexible cable within the space, the drum cover defining a cable outlet through which the flexible cable can extend.

### CROSS-REFERENCE TO RELATED APPLICATIONS

This application claims priority to U.S. Provisional Patent Application No. 63/624,404, filed Jan. 24, 2024, and U.S. Provisional Patent Application No. 63/582,972, filed Sep. 15, 2023, the entire contents of which are incorporated herein by reference.

### BACKGROUND OF THE DISCLOSURE

The present application relates to drain cleaning devices for cleaning drains, pipes, or other conduits, and specifically, to a flexible shaft drain cleaner.

Flexible shaft drain cleaners are known as high speed drain cleaners because they include motors that spin the cable at higher speeds. The higher speed is produced by directly driving the cable with torque from a motor/drive mechanism. In addition, flexible shaft drain cleaners include improved cables to withstand the higher speeds. Flexible shaft cables are different from traditional drain cleaner cables and typically include wound cables that are encased by sheaths.

### SUMMARY

In one independent aspects, the invention relates to a drain cleaning device including: a housing; a drum assembly supported by the housing, the drum assembly including an inner drum, an outer drum, and a space defined therebetween, the drum assembly configured to rotate relative to the housing about a rotation axis; a motor supported by the drum assembly, the motor including an output shaft; a flexible cable stored within the space of the drum assembly, the flexible cable operable to receive torque from the motor; and a drum cover supported by the housing and positioned over the space to maintain the flexible cable within the space, the drum cover defining a cable outlet through which the flexible cable can extend.

In some aspects, the invention relates to a drain cleaning device including: a housing including a cylindrical wall with an open front end and a closed rear end, the cylindrical wall defining a cavity; a handle extending from a first side of the cylindrical wall; a stand positioned on a second side of the cylindrical wall opposite from the handle; a drum assembly received in the cavity and supported by the housing, the drum assembly including an inner drum, an outer drum, and a space defined therebetween, the space configured to receive a flexible cable; a motor supported by the drum assembly, the motor including an output shaft; a battery receptacle supported by the drum assembly, the battery receptacle configured to receive a battery pack to supply power to the motor; and a control portion supported on the housing between the handle and the drum assembly, the control portion including control electronics and an actuator to control operation of the motor.

In some aspects, the invention relates to a drain cleaning device including: a housing including a top side, a bottom side opposite the top side, a rear side, and a front side opposite the rear side; a drum assembly supported by the housing, the drum assembly including an inner drum, an outer drum, and a space defined therebetween, the drum assembly configured to rotate about a rotation axis; a motor supported by the drum assembly, the motor including an output shaft; a flexible cable stored within the space, the flexible cable operable to receive torque from the motor; and a stand supported by the housing adjacent the bottom side, the stand being movable relative to the housing between a storage position, in which the stand is positioned directly adjacent a portion of the housing and is configured to support the housing on a surface in an upright position, and a use position, in which the stand extends outwardly from the housing.

Other aspects of the invention will become apparent by consideration of the detailed description and accompanying drawings.

### BRIEF DESCRIPTION OF THE DRAWINGS

FIG. 1 is a front perspective view of a drain cleaning device.

FIG. 2 is a rear perspective view of the drain cleaning device of FIG. 1.

FIG. 3 is a cross-sectional view of the drain cleaning device of FIG. 1 taken across lines 3-3 of FIG. 1.

FIG. 3A is a perspective view of the drain cleaning device of FIG. 1 detailing a roller bearing.

FIG. 4 is a cross-sectional view of the drain cleaning device of FIG. 1 taken across lines 4-4.

FIG. 5 is a perspective view of a direction switch for the drain cleaning device of FIG. 1.

FIG. 6 is a schematic view illustrating a system including the drain cleaning device of FIG. 1 and a camera unit.

FIG. 7 illustrates the drain cleaning device of FIG. 1 in a use position with a stand in a stored position.

FIG. 8 illustrates the drain cleaning device of FIG. 1 in the use position with the stand in a use position.

FIG. 9 is a front perspective view of a drain cleaning device according to another embodiment.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

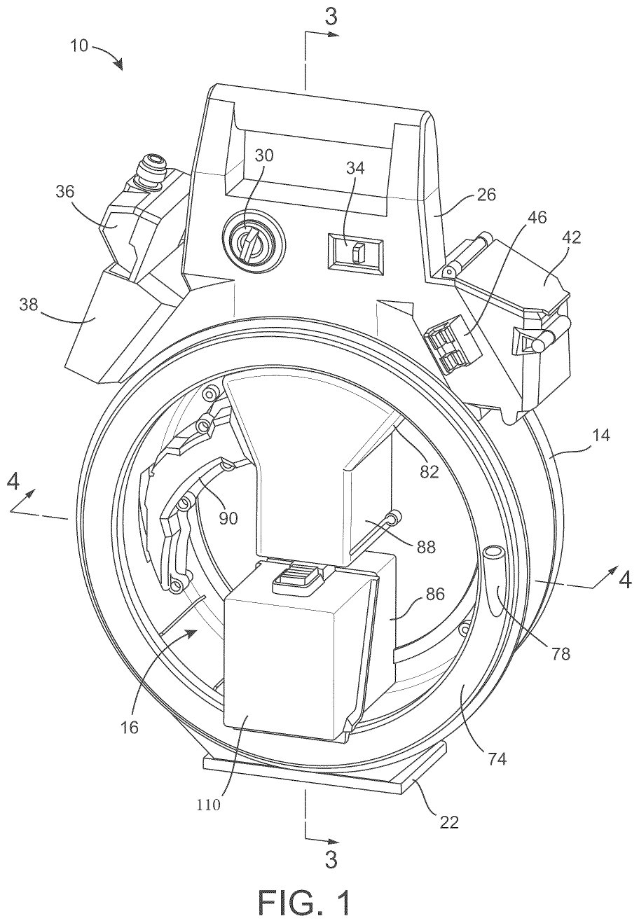

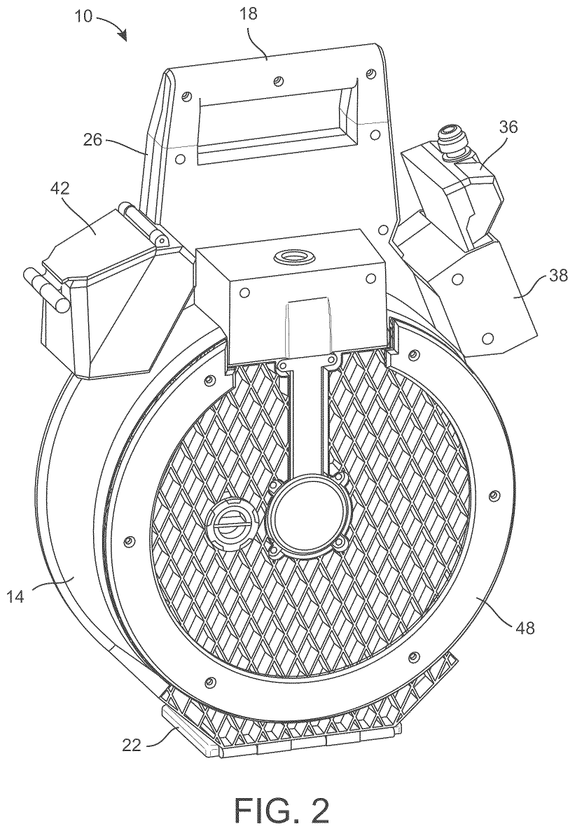

FIGS. 1 and 2 illustrate a drain cleaning device 10 that is operable to clear and clean debris from pipes or other conduits. In the illustrated embodiment, the drain cleaning device 10 is a flexible shaft drain cleaner. The drain cleaning device 10 is operable to spin a drain cleaning cable at a relatively high speed. As described below, the drain cleaning cable may include a wound cable, or other suitable flexible cable, positioned within a sheath. The wound cable is driven (e.g., spun) by the drain cleaning device 10 within the sheath to clear debris from a conduit. In the illustrated embodiment, the drain cleaning device 10 may be referred to as a mini or small flexible shaft drain cleaner. For instance, the drain cleaning device 10 may include a ¼ inch diameter cable that is around 35 feet long whereas standard flexible drain cleaning devices may include a 5/16 inch diameter cable that is approximately 75 feet long. As such, the drain cleaning device 10 is lighter and easier to transport than standard flexible drain cleaning devices.

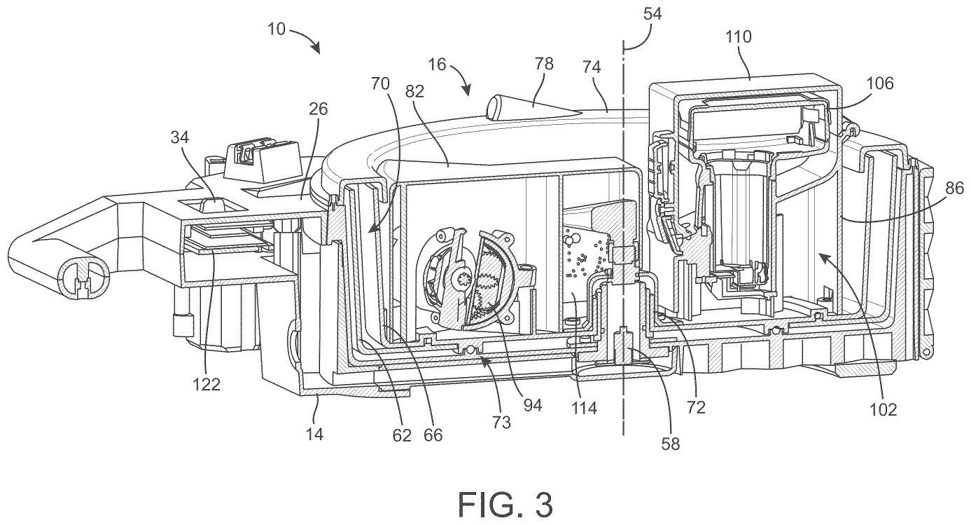

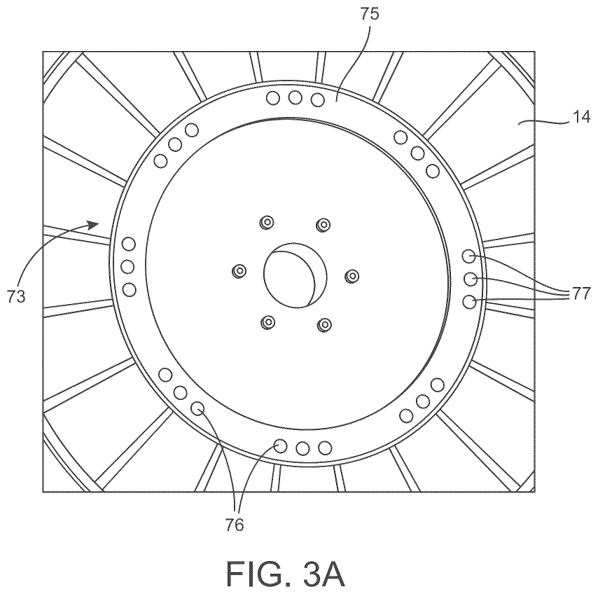

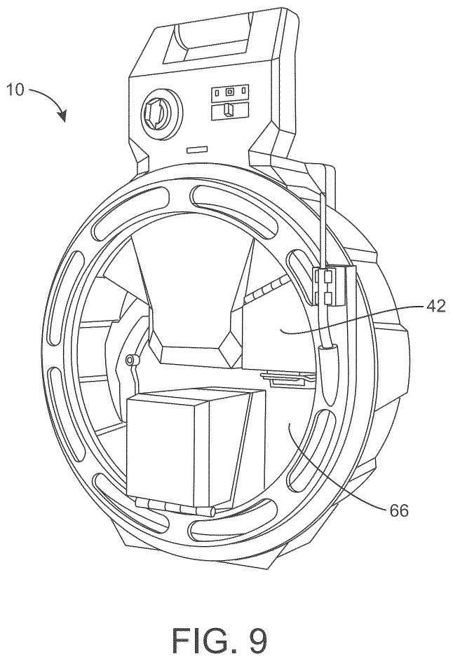

The drain cleaning device 10 includes a housing 14 and a drum assembly 16 supported by the housing 14. The housing 14 defines an outer cylindrical wall that has a closed rear end and an open front end. The cylindrical wall defines a cavity that receives the drum assembly 16. The housing 14 includes a stationary handle 18 on a first or top side of the housing 14, and a stand 22 at a second or bottom side of the housing 14. The housing 14 includes a control portion 26 (e.g., a control panel) positioned beneath the handle 18. The control portion 26 includes a user interface. In the illustrated embodiment, the user interface includes a speed control dial 30, a direction switch 34, and a foot pedal 36 that is operable to activate the drain cleaning device 10. In other embodiments, the user interface may have other configurations and/or may include fewer or more actuators. In some embodiments, the drain cleaning device 10 may be activated with a drill style trigger or button. The drill style trigger or button may be positioned on the control portion 26 of the housing 14 or another portion of the drain cleaning device 10 (e.g., on the handle 18). The foot pedal 36 may be supported by a receptacle 38 coupled to the housing 14. The housing 14 also supports a storage receptacle 42 opposite the receptacle 38 that a user may store a battery pack, cable accessories, etc. In other embodiments, as shown in FIG. 9, the receptacle 38 for the foot pedal 36 and/or the storage receptacle 42 may be positioned or coupled to the drum assembly 16 on the inside of the inner drum 66. A cable clip 46 is also supported on the storage receptacle 42 to support a cable (not shown) when not in use. In some embodiments, the housing 14 may be supported by a cage-like frame that supports the drain cleaning device 10. The frame or the housing 14 may support wheels that allow a user to transport the drain cleaning device 10 over a surface. In other embodiments, the handle 18 may be an extendible handle to assist a user transporting the drain cleaning device 10. The housing 14 also includes a support plate coupled to a rear side of the housing 14. The drain cleaning device 10 is moveable between an upright position (FIG. 1), in which the stand 22 supports the drain cleaning device 10 on a surface, and a use position (FIG. 3), in which the support plate 48 supports the drain cleaning device 10 on the surface.

With reference to FIG. 3, the drum assembly 16 is supported by the housing 14 and is rotatable relative to the housing 14 about a rotation axis 54. The drum assembly 16 is supported on the housing 14 with a support shaft 58 that defines the rotation axis 54. The drum assembly 16 includes an outer drum 62 and an inner drum 66 coupled to the outer drum 62 for co-rotation therewith. In the illustrated embodiment, the outer and inner drums 62, 66 are cylindrical-shaped with an open front end and a closed rear end. The inner drum 66 has a smaller diameter than the outer drum 62 to define a space 70 therebetween. A drain cleaning cable (not shown) may be supported within the space 70. A bearing 72 is positioned between the inner drum 66 and the support shaft 58 to allow rotation of the drum assembly 16 relative to the support shaft 58. In the illustrated embodiment, the drum assembly 16 is idly supported on the support shaft 58. In other words, the drum assembly 16 is allowed to freely rotate on the support shaft 58. In other embodiments, the drum assembly 16 may be driven by a motor to rotate with or about the support shaft 58. In addition, a surface bearing 73 is positioned between the drum assembly 16 and the housing 14. As shown in FIG. 3A, the surface bearing 73 is positioned in a recess of the housing 14 and includes a base 75 with a plurality of slots 76. The slots 76 receive a plurality of roller bearings 77 (e.g., metal balls) that are allowed to roll in place. The roller bearing 73 allows the drum assembly 16 to smoothly rotate about the rotation axis 54 without inducing unwanted friction between the housing 14 and the drum assembly 16.

With reference to FIGS. 1 and 3, a drum cover 74 is positioned over the space 70 to secure the cable between the inner drum 66, the outer drum 62, and the drum cover 74. The drum cover 74 may be coupled to the housing 14 with fasteners and is removably coupled to the housing 14. The drum cover 74 is generally circular shaped and may either partially enclose or entirely enclose the space 70 from a front end of the drum assembly 16. In other embodiments, the drum cover 74 may be other shapes and sizes. For instance, the drum cover may be crescent shaped and only cover a portion of the space from the front end. The drum cover 74 includes a cable outlet 78 that guides the cable out of the drum assembly 16. In the illustrated embodiment, the cable outlet 78 is positioned at a right hand side of the drum cover 74 or 3 o'clock position. In other embodiments, the cable outlet 78 may be positioned at the bottom of the drum cover 74 or 6 o'clock position, the left hand side of the drum cover 74 or 9 o'clock position, or the top side of the drum cover 74 or 12 o'clock position. In some embodiments, the drum cover 74 may include multiple cable outlets 78 located at different positions around the drum cover 74. In other embodiments, the cable outlet 78 may be positioned within a 360 degree range about the drum cover 74.

The drum cover 74 may be movable relative to the housing 14 to adjust a position of the cable outlet 78 relative to the housing 14. For example, the drum cover 74 may be removable from the housing 14 (e.g., by disconnecting the fasteners), and then reconnected to the housing 14 in a different orientation to adjust the position of the cable outlet 78. In other embodiments, the drum cover 74 may be rotatable relative to the housing 14 while remaining connected to the housing 14 to adjust the position of the cable outlet 78. In such embodiments, the drum cover 74 may engage, for example, a track formed on the housing 14 such that the drum cover 74 is rotatable relative to the housing 14 about the rotation axis 54.

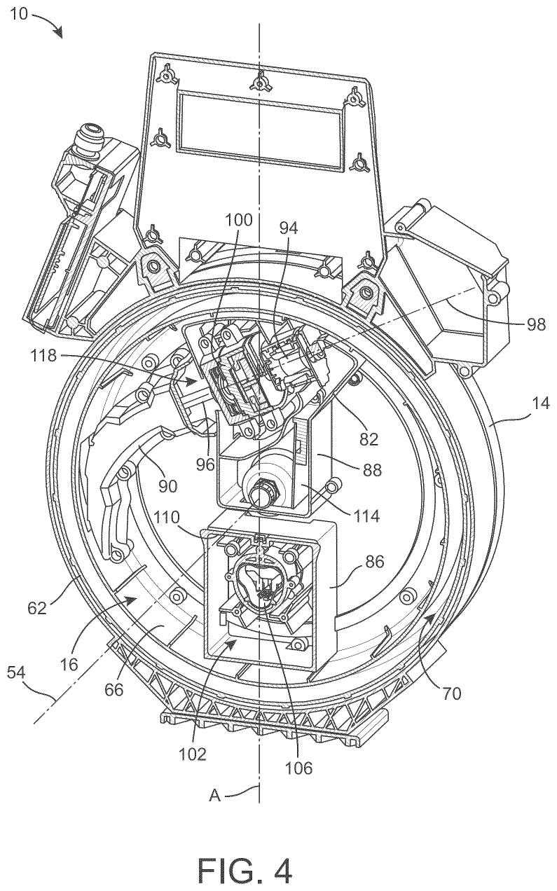

With reference to FIGS. 1 and 4, the inner drum 66 of the drum assembly 16 supports a motor housing 82, a battery housing 86, an electronics housing 88, and a cable guide housing 90. A motor 94 is supported within the motor housing 82. Specifically, an inside surface of the inner drum supports the motor housing 82, the battery housing 86, the electronics housing 88, and the cable guide housing 90. In some embodiments, the motor 94 may be a DC brushless motor. In other embodiments, the motor 94 may include a brush. As shown in FIG. 4, the motor 94 includes an output shaft 96 that defines a motor axis 98. The output shaft 96 is configured to be directly coupled to the drain cleaning cable to rotate the cable. The motor axis 98 is offset from the rotation axis 54 of the drum assembly 16. More particularly, the motor axis 98 is spaced apart from, but perpendicular to the rotation axis 54. The motor axis 98 is also orientated at an oblique angle relative to a vertical plane A (when the drain cleaning device 10 is in the upright position) extending through the rotation axis 54. The vertical plane A extends through the support shaft 58 and the motor 94. The vertical plane A also extends through the battery housing 86. In other embodiments, the output shaft 96 may be oriented in other configurations. A transmission 100 or gear train is also supported in the motor housing 82 and is positioned between the motor 94 and the output shaft 96. In the illustrated embodiment, the transmission 100 transfers torque from the motor 94 to the output shaft 96 so that the output shaft 96 directly drives the wound cable to rotate within the sheath. For example, the transmission 100 may include a planetary gear system including a single stage or multiple stages, a planetary gearset with a bevel gear set, a planetary gearset with two bevel gearsets, only two bevel gearsets, a spur gearset, a helical gearset, a multi-speed gearbox, or a continuously variable gearbox. In some embodiments, the transmission 100 may be considered part of the motor 94. In other embodiment, the transmission 100 may be a separate component from the motor 94 that may be interchanged with another transmission.

With reference back to FIGS. 1 and 4, the battery housing 86 defines a battery receptacle 102 configured to receive a battery pack 106. In the illustrated embodiment, the battery receptacle 102 is positioned on a diametrically opposite side of the rotation axis 54 from the motor 94. The battery pack 106 may include any of number of different nominal voltages (e.g., 12V, 18V, etc.), and may be configured having any of number of different chemistries (e.g., lithium-ion, nickel-cadmium, etc.). The battery pack 106 is operable to supply power to the motor 94 to energize the motor 94. The battery pack 106 is a removable battery pack. The battery pack 106 is also a rechargeable battery pack. Alternatively, the motor 94 may be powered by a remote power source (e.g., a household electrical outlet) through a power cord. In the illustrated embodiment, the battery pack 106 is inserted into the battery receptacle 102 in a direction that is parallel to the rotation axis 54. As such, the battery pack 106 is mounted with its longitudinal axis parallel with the rotation axis 54. In other embodiments, the battery pack 106 may be inserted into the battery receptacle 102 in a direction that is perpendicular or oblique to the rotation axis 54. In further embodiments, the battery receptacle 102 may be positioned elsewhere on the drain cleaning device 10. For example, the battery receptacle 102 may be mounted on the housing 14. In such an embodiment, the battery pack 106 would not spin with the drum assembly 16 during a drain cleaning operation. Further, the battery receptacle 102 may be positioned adjacent the center of the inner drum 66. The battery housing 86 also includes a battery cover 110 that is selectively pivotable to enclose the battery pack 106 within the battery housing 86. The battery cover 110 may be coupled to the battery housing 86 with a clip or other fastener. When the battery cover 110 is in a closed position, the battery housing 86 surrounds the battery pack 106 to inhibit fluids or other debris that may be expelled during operation of the drain cleaning device 10 from tampering with the battery pack 106.

Control electronics 114 are disposed within the electronics housing 88. The electronics housing 88 is adjacent the motor housing 82. In some embodiments, the electronics housing 88 and the motor housing 82 may be integrally formed so that the motor 94 and the control electronics 114 are within the same interior. The control electronics 114 may include a controller or processor that controls operation of the drain cleaning device 10. In some embodiments, the controller is implemented as a microprocessor with separate memory. In other embodiments, the controller may be implemented as a microcontroller (with memory on the same chip). In other embodiments, the controller may be implemented using multiple processors. In addition, the controller may be implemented partially or entirely as, for example, a field-programmable gate array (FPGA), an application specific integrated circuit (ASIC), and the like, and the memory may not be needed or be modified accordingly. The memory may include non-transitory, computer readable memory that stores instructions that are received and executed by the controller to carry out functionality of the drain cleaning device 10 described herein. The memory may include, for example, a program storage area and a data storage area. The program storage area may include combinations of different types of memory, such as read-only memory and random-access memory.

With reference to FIG. 4, the cable guide housing 90 is coupled to the inner drum 66 adjacent the motor housing 82. The cable guide housing 90 defines a cavity 118 and a guide channel (not shown) extending from the cavity 118. The output shaft 96 of the motor 94 extends from the motor housing 82 into the cavity 118 in a direction that is aligned with the guide channel. The guide channel extends into the inner drum 66 and extends into the space 70 defined between the inner and outer drums 62, 66. A first end of the cable is coupled to the output shaft 96 of the motor 94 and extends through the cable guide housing 90 and into the space 70 defined between the outer and inner drums 62, 66.

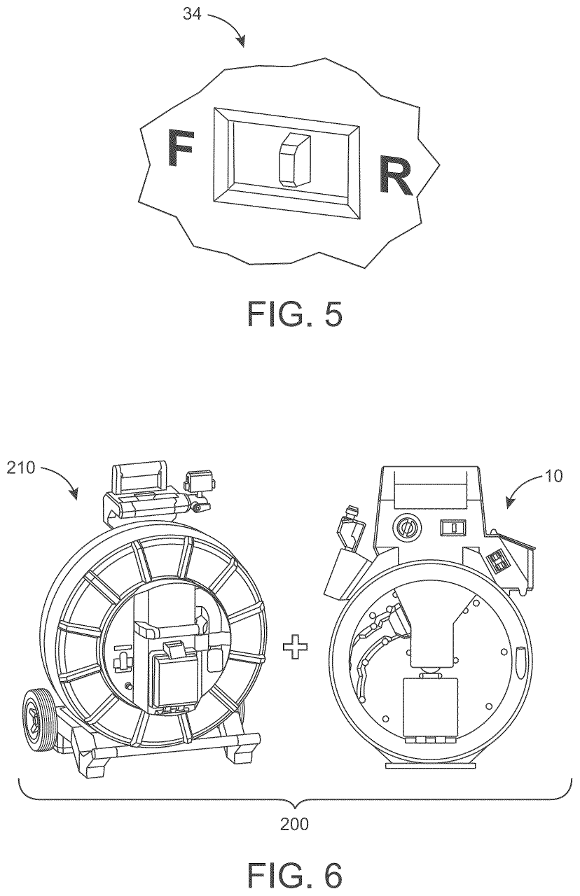

With reference to FIG. 5, the direction switch 34 is operable to switch the rotation direction in which the motor 94 rotates the cable (i.e., forward or reverse). Control electronics 122 (FIG. 3) are supported within the control portion 26 of the housing 14. The control electronics 122 are operable to communicate and send signals from the direction switch 34 and the speed control dial 30 to the control electronics 114 within the electronics housing 88. The control electronics 122 may be similar to the control electronics 114 described above. Generally, the user will use the drain cleaning device 10 with the motor 94 rotating the cable in the forward direction. However, if the user uses the drain cleaning device 10 in reverse for too long or continuously, it may wear out the cable. In order to prevent or discourage this use, the control electronics 114 control the motor 94 to run in reverse in bursts rather than continuously. In some embodiments, the drain cleaning device 10 may include an indicator such as a LED light or a sound alert to let the user know that the motor 94 is in reverse or has been in reverse for too long. In other words, the control electronics 122 may send an alert to a user if the output shaft 96 of the motor 94 rotates a predetermined direction (i.e., reverse) for a predetermined amount of time. In another embodiment, the drain cleaning device 10 may include a mechanical mechanism such as a spring-loaded lever or button that a user depresses in addition to normal actuation in order to make the drain cleaning device 10 run in reverse mode. For example, a reverse button may be positioned on the control portion 26 of the housing 14 that a user keeps depressed while activating the motor 94 in order for the motor 94 to run in reverse and rotate the cable in reverse. The speed control dial 30 may be rotated to control the speed at which the motor 94 rotates the cable.

FIG. 6 illustrates a system 200 including the drain cleaning device 10 and a camera unit 210. The drain cleaning device 10 and the camera unit 210 may be used in tandem to clear debris from a drain. For example, the camera unit 210 includes a camera at an end of a cable that may be inserted into a drain to identify a clog or debris. Once a clog is identified, the drain cleaning device 10 may be used to clear the clog. In some embodiments, the drain cleaning device 10 and the camera unit 210 may include latches or other features that are configured to couple the two together for easy transport, maneuverability, and operation.

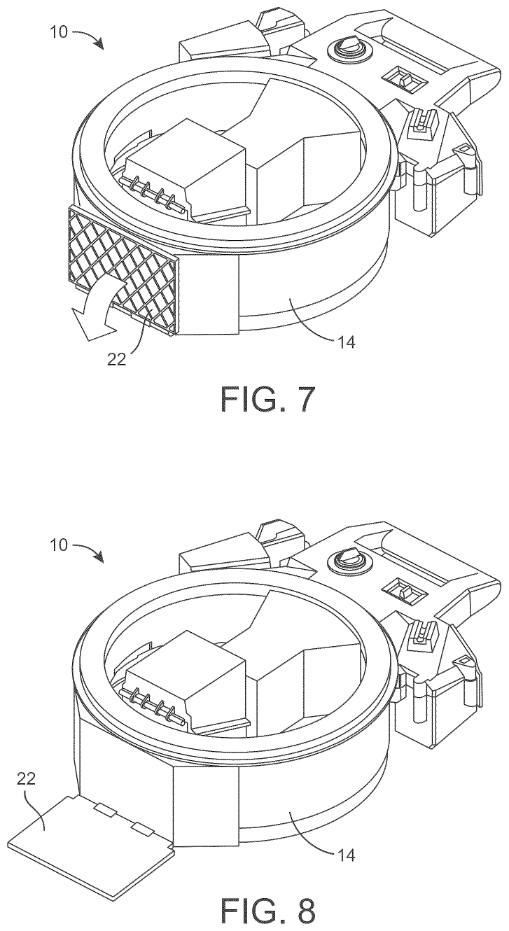

With reference to FIGS. 7 and 8, the stand 22 is operable to support the drain cleaning device 10 in an upright position when not in use. The stand 22 is moveable between a storage position (FIG. 7) and a use position (FIG. 8). In the storage position, the stand 22 is directly adjacent a portion of the housing 14. That is, the stand 22 may be in contact with, flush with, and/or at least partially received in the housing 14. In the use position, the stand 22 extends outwardly from the housing 14. In the illustrated embodiment, the stand 22 is pivotable between the storage and use positions. For example, an edge of the stand 22 may be coupled to a bottom of the housing 14 by a hinge. The hinge may include a detent-type mechanism to releasably secure the stand in the storage position and/or the use position. In other embodiments, the stand 22 may slide linearly between the positions out of and into the housing 14 or along an outer surface of the housing 14. In the storage position, the stand 22 extends generally tangential to the bottom side of the housing 14. In some embodiments, the bottom side of the housing 14 may be planar rather than rounded. In such embodiments, the stand 22 may extend generally parallel to the bottom side of the housing 14. In the use position, the stand 22 extends generally perpendicularly from the housing 14. In addition, the stand 22 is generally coplanar with the rear side of the housing 14. In this position, a user may place their foot or other heavy object on a surface 126 of the stand 22 to help stabilize the drain cleaning device 10 and inhibit the drain cleaning device 10 from moving during operation. In other embodiments, the stand 22 may be stationary in either the use or storage position.

In the illustrated embodiment, the drain cleaning cable is also known as a flexible shaft cable. Compared to typical drain cleaning cables, the flexible shaft cable includes a wound cable that is encased by a sheath. The wound cable is operable to be rotated by the motor 94 within the sheath. The flexible shaft cable includes a first end that is coupled to the motor 94 and a second end that is operable to be extended into a drain to facilitate clearing the drain. Specifically, the wound cable is directly coupled to the output shaft 96 of the motor 94 at the first end of the cable to rotate the wound cable within the sheath. The portion of the cable between the first and second ends extends from the output shaft 96 through the cavity 118 to be coiled within the space 70 between the inner and outer drums 62, 66. The second end of the cable extends from the space 70 and through the cable outlet 78 on the drum cover 74.

In some embodiments, the drain cleaning device 10 includes a clutch disposed between the output shaft 96 of the motor 94 and the first end of the cable. The clutch may be operable to allow slip between the output shaft 96 and the cable if the output torque of the motor 94 exceeds a predetermined limit to protect the cable. For example, the clutch could be a mechanical clutch, such as a radial roller clutch. Alternatively, the clutch may be a ball spring clutch, a friction plate, a friction cone, and electromechanical clutch, and the like. The mechanical clutch may include a first setting for when the motor 94 rotates the output shaft 96 in a forward direction and a second setting for when the motor 94 rotates the output shaft 96 in a reverse direction. The first setting and the second setting may be different. For example, the second setting may allow the clutch to slip at a lower predetermined limit than the second setting.

In other embodiments, the clutch may be an electronic clutch that senses the output torque of the motor 94 by, for example, sensing the current supplied to the motor 94 from the battery pack 106. The electronic clutch may then allow slip to occur if the electronic clutch senses that the output torque from the motor 94 was above a predetermined limit. Alternatively, the electronic clutch may sense when the current is above the predetermined limit and communicate with the control electronics 114 to depower the drain cleaning device 10.

During operation of the drain cleaning device 10, a user may extend the second end of the cable into a drain or other conduit. As the cable is payed out from the drum assembly 16, the drum assembly 16 rotates in a first direction. Once the second end of the cable encounters a clog, the user may depress the foot pedal 36 to activate the motor 94 and rotate the wound cable within the sheath. Based on the position of the direction switch 34, the wound cable will spin either clockwise or counterclockwise within the sheath. As the wound cable rotates, the cable accessory assists in removing the debris or clog. Alternatively, a user may force the second end of the cable past the debris within a drain first before activating the motor 94. Then, the user may depress the foot pedal 36 to activate the motor 94 while retracting the cable out of the drain. The motor 94 rotates the wound cable and thus the cable accessory to remove the debris or clog. The user may also adjust the speed control dial 30 to adjust the revolutions of the wound cable and cable accessory if needed for a larger or smaller clog. While the cable is being retracted from the drain, the drum assembly 16 rotates in a second direction, opposite the first direction, to wind the cable back within the space 70. Once the drain has been sufficiently removed of debris and clogs, the user can then retract the cable from the drain to store the cable within the drum assembly 16.

In some embodiments, the control electronics 114 may include a wireless communication device to communicate with an external device, such as a smart phone or tablet. The wireless communication device communicates with the control electronics 114 based on user input from the external device. For example, a user may use the external device to define operating parameters of the drain cleaning device 10 such as minimum and maximum torque or revolutions per minutes of the output shaft 96 of the motor 94.

Providing a drain cleaning device 10 with a motor 94 that directly drives a cable allows the cable to rotate at higher torque compared to drain cleaning devices that rely on driving a drum assembly to produce friction to rotate the cable. Rotating the cable at higher torque more efficiently cleans a drain or other conduit.

Although the invention has been described in detail with reference to certain preferred embodiments, variations and modifications exist within the scope and spirit of one or more independent aspects of the invention as described.

Various features of the disclosure are set forth in the following claims.

What is claimed is:

1. A drain cleaning device comprising:
a housing;
a drum assembly supported by the housing, the drum assembly including an inner drum, an outer drum, and a space defined therebetween, the drum assembly configured to rotate relative to the housing about a rotation axis;
a motor supported by the drum assembly, the motor including an output shaft;
a flexible cable stored within the space of the drum assembly, the flexible cable operable to receive torque from the motor; and
a drum cover supported by the housing and positioned over the space to maintain the flexible cable within the space, the drum cover defining a cable outlet through which the flexible cable can extend.

2. The drain cleaning device of claim 1, wherein the drum cover is moveable relative to the housing to adjust a position of the cable outlet relative to the housing.

3. The drain cleaning device of claim 2, wherein the drum cover is removable from and reconnectable to the housing to adjust the position of the cable outlet.

4. The drain cleaning device of claim 2, wherein the drum cover is rotatable relative to the housing while connected to the housing to adjust the position of the cable outlet.

5. The drain cleaning device of claim 1, further comprising a battery receptacle supported by the drum assembly, the battery receptacle configured to receive a battery pack to supply power to the motor.

6. The drain cleaning device of claim 1, wherein the housing includes a stand that supports the housing in an upright position on a surface.

7. The drain cleaning device of claim 6, wherein the stand is moveable relative to the housing between a storage position, in which the stand is positioned directly adjacent a portion of the housing, and a use position, in which the stand extends outwardly from the housing.

8. The drain cleaning device of claim 1, further comprising:
control electronics to control operation of the motor; and
a direction switch coupled to the control electronics and operable to switch a direction in which the motor rotates the flexible cable.

9. A drain cleaning device comprising:
a housing including a cylindrical wall with an open front end and a closed rear end, the cylindrical wall defining a cavity;
a handle extending from a first side of the cylindrical wall;
a stand positioned on a second side of the cylindrical wall opposite from the handle;
a drum assembly received in the cavity and supported by the housing, the drum assembly including an inner drum, an outer drum, and a space defined therebetween, the space configured to receive a flexible cable;
a motor supported by the drum assembly, the motor including an output shaft;
a battery receptacle supported by the drum assembly, the battery receptacle configured to receive a battery pack to supply power to the motor; and
a control portion supported on the housing between the handle and the drum assembly, the control portion including control electronics and an actuator to control operation of the motor.

10. The drain cleaning device of claim 9, wherein the drum assembly is rotatable relative to the housing, and wherein the battery receptacle and the motor are supported on an inside surface of the inner drum for rotation therewith.

11. The drain cleaning device of claim 10, further comprising a surface bearing positioned between the housing and the drum assembly to facilitate rotation of the drum assembly relative to the housing.

12. The drain cleaning device of claim 9, further comprising a first storage receptacle supported by the housing adjacent the handle.

13. The drain cleaning device of claim 12, further comprising a second storage receptacle supported by the housing adjacent the handle and on an opposite side of the handle from the first storage receptacle.

14. The drain cleaning device of claim 9, wherein the actuator is a speed control dial operable to adjust a speed of the motor.

15. The drain cleaning device of claim 9, wherein the actuator is a direction switch operable to switch a rotation direction of the motor.

16. A drain cleaning device comprising:
a housing including a top side, a bottom side opposite the top side, a rear side, and a front side opposite the rear side;
a drum assembly supported by the housing, the drum assembly including an inner drum, an outer drum, and a space defined therebetween, the drum assembly configured to rotate about a rotation axis;
a motor supported by the drum assembly, the motor including an output shaft;
a flexible cable stored within the space, the flexible cable operable to receive torque from the motor; and
a stand supported by the housing adjacent the bottom side, the stand being movable relative to the housing between a storage position, in which the stand is positioned directly adjacent a portion of the housing and is configured to support the housing on a surface in an upright position, and a use position, in which the stand extends outwardly from the housing.

17. The drain cleaning device of claim 16, wherein the housing includes a support plate on the rear side of the housing that supports the housing when the stand is in the use position.

18. The drain cleaning device of claim 16, wherein the stand is pivotable between the storage position and the use position.

19. The drain cleaning device of claim 16, wherein the stand extends generally perpendicularly from the bottom side of the housing when in the use position.

20. The drain cleaning device of claim 19, wherein the stand is generally coplanar with the rear side of the housing when in the use position.
